(19) United States
(12) Patent Application Publication
(10) Pub. No.: US 2016/0117680 A1
(43) Pub. Date: Apr. 28, 2016

(54) PAYMENT PROCESSING

(71) Applicant: HEWLETT-PACKARD DEVELOPMENT COMPANY, L.P., Houston, TX (US)

(72) Inventors: Tomer Priel, Yehud (IL); Adi Kidron, Yehud (IL); Eli Mordechai, Yehud (IL)

(21) Appl. No.: 14/898,519

(22) PCT Filed: Jun. 27, 2013
(86) PCT No.: PCT/US2013/048112

§ 371 Date: Dec. 15, 2015

(51) Int. Cl. G06Q 20/40; G06Q 20/38

(52) U.S. Cl. CPC G06Q 20/405; G06Q 20/385

(57) ABSTRACT

Payment processing as disclosed includes maintaining registration data and masked payment data so that it is accessible to a computing device. The registration data represents a registration of the computing device with a remote payment processing system. The masked payment data indirectly, but not directly, identifies payment data associated with a user. An application programming interface for receiving a payment request from a merchant application is exposed. In response to receiving the payment request for an amount via the interface, the user is prompted for authorization data. Only upon verification of the authorization data, the registration data, the masked payment data, and the amount are communicated to the payment processing system.

### BACKGROUND

For many credit card transactions, a purchaser supplies a credit card number plus verification data such as an address, a personal identification number, or other code to a merchant. The merchant then supplies the same information to credit card processor who in turn initiates a transaction to charge the purchaser's credit card account. Assuming a valid credit card number and verification details were provided and the existence of available credit or funds, the processor returns a transaction data that the merchant can later use to claim payment.

### DRAWINGS

FIG. 1 depicts an environment in which various embodiments may be implemented.

FIG. 2 depicts a sequence diagram depicting interactions between the complements of FIG. 1 according to an example.

FIGS. 3 and 4 depict example user interfaces.

FIGS. 5-6 depict examples of physical and logical components for implementing various embodiments.

### DETAILED DESCRIPTION

### Introduction

Security is an ever important concern with monetary transactions. For credit and debit transactions, purchasers are supplied with a physical payment card. The physical card visually displays payment data such as an account number and other security details such as a card verification code. The card can also include a storage medium such as a magnetic strip or near field communication tag to store such payment data. Use of a physical object to facilitate a transaction provides a level of security. The card provides an account holder with a sense of ownership and, by its physical nature, can only be used by its holder.

On line transactions cannot fully benefit from the security allowed by using a physical card as use of a physical card is not strictly required. For the least secure online transactions, the purchaser is simply asked to supply the credit card number with no further verification that the purchaser is in possession of the physical card. For more secure transactions, the purchaser is asked to supply the credit card number and the card verification code imprinted on the card. Here, there is at least the presumption that the purchaser has or had possession of the physical card. For yet more secure online transactions, the purchaser is asked for a personal identification number or other verification data not disclosed by the physical card. This additional data is matched to the account data on a backend to verify that the purchaser is the apparent owner or authorized user of the card.

In each of the scenarios above, the purchaser is asked to disclose personal details to a merchant. These details, referred to herein as payment data, can include a credit card number, card verification number, address, and a personal identification number. The merchant then passes that payment data on to a payment processor. While safeguards can be put in place, disclosure of the payment data poses a security risk especially when dealing with unscrupulous or a compromised merchant. In such cases, the payment data might be reused, sold, or stolen with the card owner learning only after unauthorized transactions have been processed.

Various embodiments, described in detail below, facilitate on line credit card transactions without asking the purchaser to provide payment data to a merchant while also restoring the additional security of utilizing a personal, physical object to facilitate complete a transaction. Here that physical object is a computing device such as a smart phone, tablet or any computing device that can be personal to a purchaser. Examples described below allow a smart phone and the data it stores to emulate a physical card and act as an intermediary between a merchant requesting payment and a payment processor.

The following description is broken into sections. The first, labeled “Environment,” describes an environment in which various embodiments may be implemented. The second section, labeled “Operation,” describes steps taken to implement various embodiments. The third section, labeled as “Components” describes examples of various physical and logical components for implementing various embodiments.

### Environment

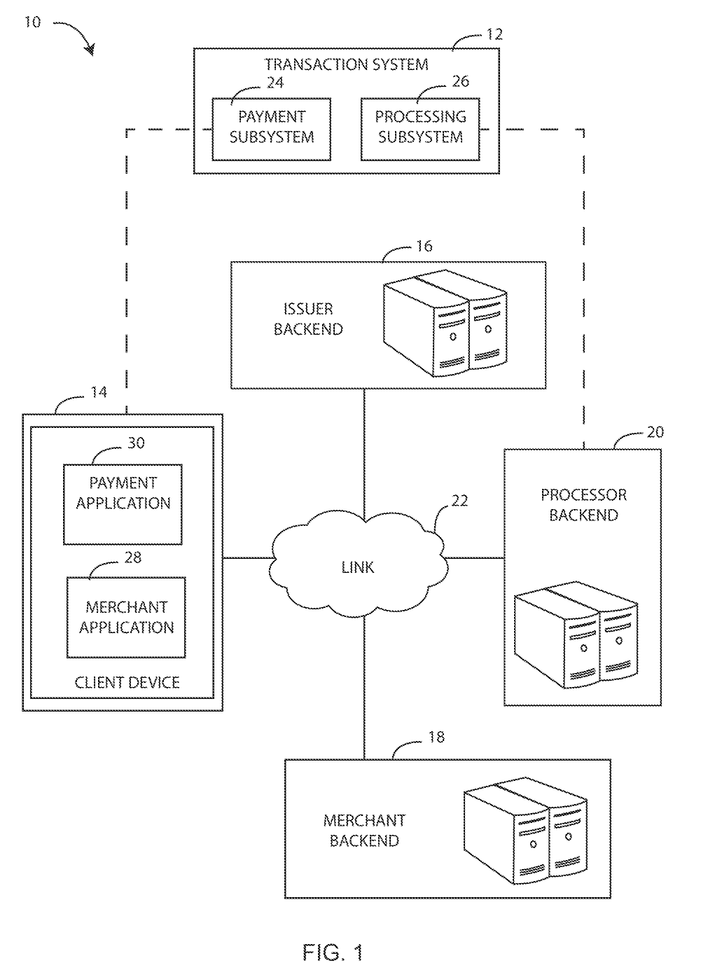

FIG. 1 depicts an environment 10 in which various embodiments may be implemented. Environment 10 is shown to include transaction system 12, client device 14, issuer backend 16, merchant backend 18, and processor backend 20. Transaction system 12, described in more detail below, represents a combination of programming and hardware for processing monetary transactions between a user of client device 14 and merchant 18. Client device 12 represents generally any computing device that can be personal to a payment card holder. Issuer backend 16 represents an information technology (IT) infrastructure maintained by an issuer of a payment card. Merchant backend 18 represents an IT infrastructure maintained by a merchant. As used herein, the term merchant means any person that offers goods or services in exchange for monetary payment. Processor backend 20 represents an IT infrastructure maintained by a processor of payment card transactions. It is noted that the issuer and the processor may be the same such that IT backends 16 and 20 are integrated.

Client device 14, issuer backend 16, merchant backend 18 and processor backend 20 are interconnected via link 22. Link 22 represents generally one or more of a cable, wireless, fiber optic, or remote connections via a telecommunication link, an infrared link, a radio frequency link, or any other connectors or systems that provide electronic communication. Link 22 may include, at least in part, an intranet, the Internet, or a combination of both. Link 22 may also include intermediate proxies, routers, switches, load balancers, and the like.

Transaction system 12 is shown to include payment subsystem 24 and processing subsystem 26. Payment subsystem 24 represents programing and hardware configured to receive a payment request from a merchant, and if authorized by a user, communicate payment data to processing subsystem 26 for use in initiating a corresponding monetary transaction. Processing subsystem 26 represents programing and hardware configured to verify and utilize data received by payment subsystem 24 to initiate a monetary transaction between a user of client device 14 and the requesting merchant.

Payment subsystem 24 is implemented by client device 14 executing payment application 30. In the example of FIG. 1, client device 14 is shown to include merchant application 28 and payment application 30. Merchant application 30 represents an application executable by client device 14, through which a user of client device 14 may request a product or service from a merchant, and communicate a payment request for a corresponding amount to payment application 30. Payment application 30 represents an application executable by client device 14 to act as an intermediary between merchant application 28 and processing a payment processor in completing the requested payment.

Payment application 30 when executed configures client device 14 to maintain registration data and masked payment data. The registration data links client device 14 to a payment account maintained by processor backend 20. The masked payment data is data that indirectly, but not directly, identifies payment data. For example, the masked payment data may be a hash of the payment data. Thus, by itself, the masked payment data has no value as it cannot be used alone to complete a transaction and without extraordinary effort cannot be used aloe to derive the payment data. It is noted that payment application does not cause client device 14 to persistently store such payment data.

In response to a payment request from merchant application 28, payment application 30, when executed, causes client device 14 to obtain payment authorization from the user and then pass the payment request, the registration data, and the masked payment data to processing subsystem 26 implemented by processor backend 20. Assuming, a transaction for the payment request is successfully initiated using that data, payment application 30 receives and passes transaction data back to merchant application 28. Merchant application 28 passes the transaction data to merchant backend 18 where it is used to claim payment from processor backend 20.

### Operation

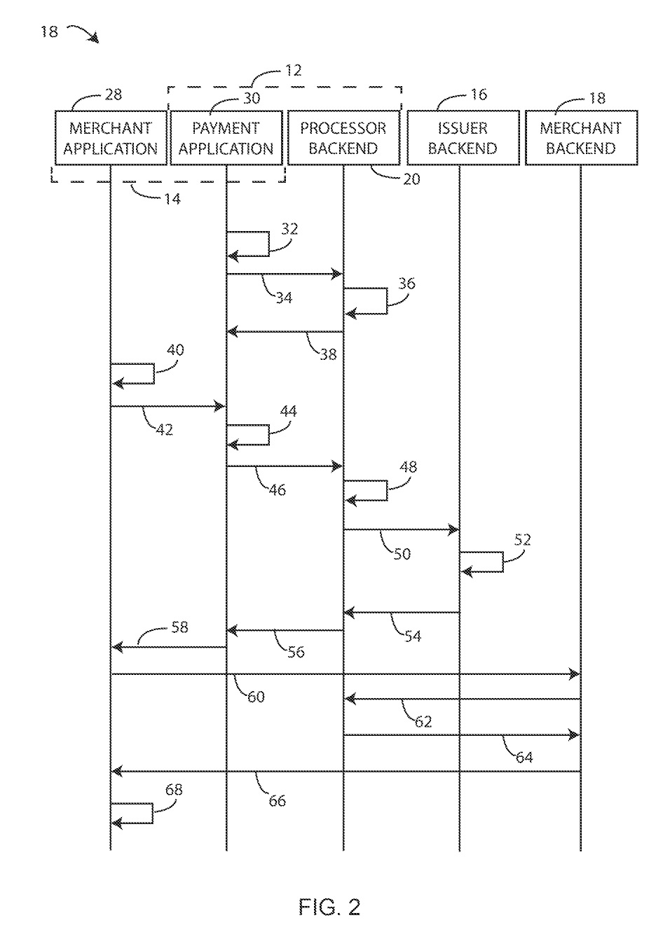

FIG. 2 is an example sequence diagram depicting a sequence of communications between components of FIG. 1 complete a monetary transaction between a user of client device 14 and a merchant. Initially, payment application 28 is installed and configured on client device 14 (step 32). Step 32 can include payment application 32 generating masked payment data from payment data supplied by a user of client device 14. That masked payment data is stored locally with respect to client device 14. Stored locally, with respect to client device 14, means stored in storage memory of client device 14 or in an external data repository associated with and accessible to client device 14. Step 32 can also involve recording a personal identification number or other code to be entered by the user to authorize a transaction.

Once installed, payment application 28 initiates communication with processor backend 20 (step 34). Payment application 30 provides data identifying itself and a payment account associated with the user of client device 14. That payment account, maintained by processor backend 20, includes payment data for completing monetary transactions between the user and a merchant. Processor backend 20 processes the data supplied by payment application and generates registration data (step 36). The registration data associates payment application 30, as installed on client device 14, with the payment account. Processor backend 20 then returns the registration data to payment application 30 which in turn stores that that data locally so that it can be repeatedly accessed along with the masked payment data (step 38).

At this point, payment application 30 is installed and configured for use. The user of client device 14 interacts with merchant application 28, identifies a desired product or service, and provides instructions to purchase the identified goods or services for an agreed amount (step 40). Merchant application 28 sends a payment request for the agreed amount to payment application 30 (step 42). Payment application 30 receives the request and prompts the user for authorization to pay amount to the merchant (step 44). Once the user enters the appropriate code to authorize payment, payment application 30 passes the payment request, registration data, and the masked payment data to processor backend 20 (step 46).

Processor backend 20 uses the registration data to identify a payment account and then verifies the masked payment data against payment data associated with the identified payment account (step 48). For example, the masked payment data may be a hash of payment data received by mobile application 30 at client device 14. Processor backend 20 may then compare that hash with a second hash of corresponding payment data from the payment account associated with the registration data. If a valid payment account cannot be identified or if the marked payment data cannot be verified, processor backend 20 returns an error. Otherwise, processor backend 20 initiates a transaction for the requested amount sending the payment request and the payment data associated with the identified payment account to issuer backend 16 (step 50).

Issuer backend 16 uses the payment data to determine if the payment account is valid and to determine if the payment account has a balance sufficient for a transaction in the requested amount (step 52). If not, issuer backend 16 returns an error that is ultimately passed to client device 14. Assuming that the transaction can proceed, issuer backend 16 returns approval to processor backend 20 (step 54). Processor backend 20 receives the approval and passes transaction data to payment application 30 (step 56). The transaction data is data for use to claim payment of the requested amount. Payment application 30 passes the transaction data to merchant application 28 (step 58) which passes the transaction data on to merchant backend 18 (step 60).

Merchant backend (18) communicates the transaction data to processor backend 20 to claim payment for the requested amount (step 62). Processor backend 64 responds with a payment conformation to merchant backend 20 (step 64). Merchant backend 20 passes approval data to merchant application 28 (step 66). Merchant application 28 causes client device 14 to notify the user of a successful transaction (step 68).

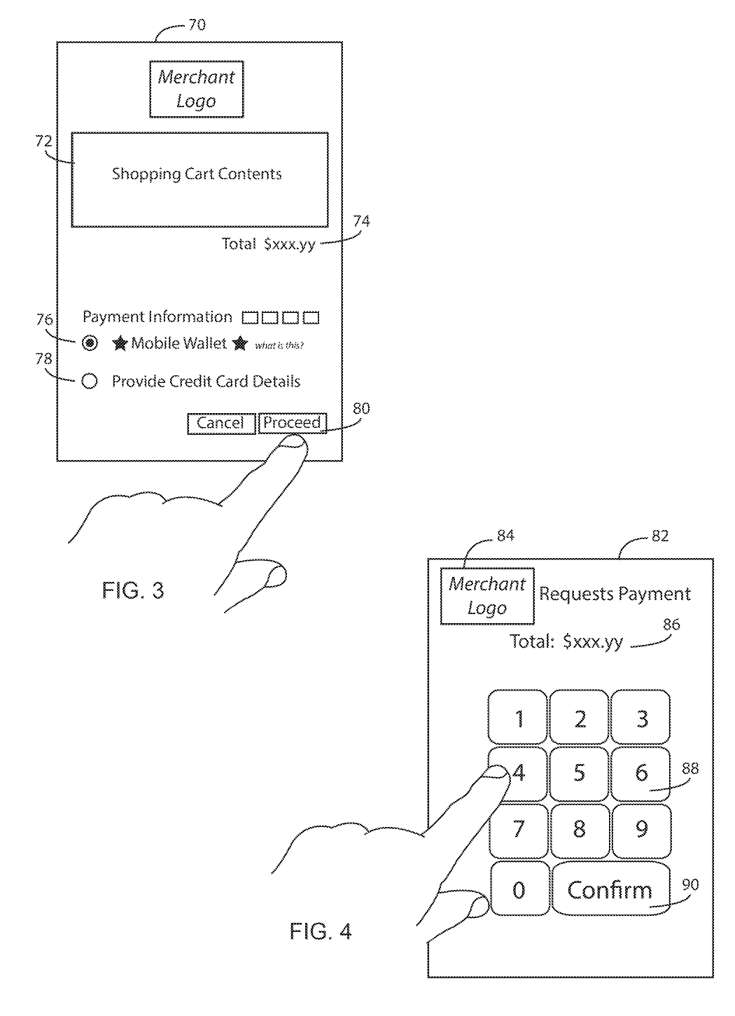

In step 40 of FIG. 2, the user interacted with merchant application 28 to provide instructions to purchase identified goods or services instructions at and agreed price. FIG. 3 depicts a screen view of an example user interface 70 caused by merchant application 28 to be displayed by client device 14. User interface 70 is shown to include a field 72 for displaying contents of a shopping cart and an agreed price 74. Interface 70 includes controls 76 and 78 for selecting different payment methods. In this example control 76 is for selecting transaction system 12 to process payment. Control 78 allows the user to select an alternate method in which the user will be asked to disclose payment data. Control 80 instructs merchant application 28 to proceed with the selected payment method.

Assuming the user has selected control 76 followed by control 80 in FIG. 3, the merchant application 28 communicates a payment request to payment application 30 as depicted in step 42 of FIG. 2. In response, at step 44, payment application prompts the user of client device 14 to authorize the request. FIG. 4 depicts a screen view of a user interface 82 caused by payment application 30 to be displayed by client device 14 providing such a prompt. User interface 82 includes data 84 identifying the merchant, data 86 identifying the requested purchase amount and controls 88 for entering an authorization code such as a personal identification number. With the code entered, the user selects control 90 to confirm authorization and allow payment application 30 to proceed with the transaction.

In this fashion, client device 14 functions like a physical payment card providing its user with a physical object used to facilitate a monetary transaction. As added security measures, payment data is not shared with merchant application 28 or merchant backend 18. Furthermore, the client device 14 is only used to maintain masked payment data, which in and of itself, is not useful if stolen or otherwise compromised.

### Components

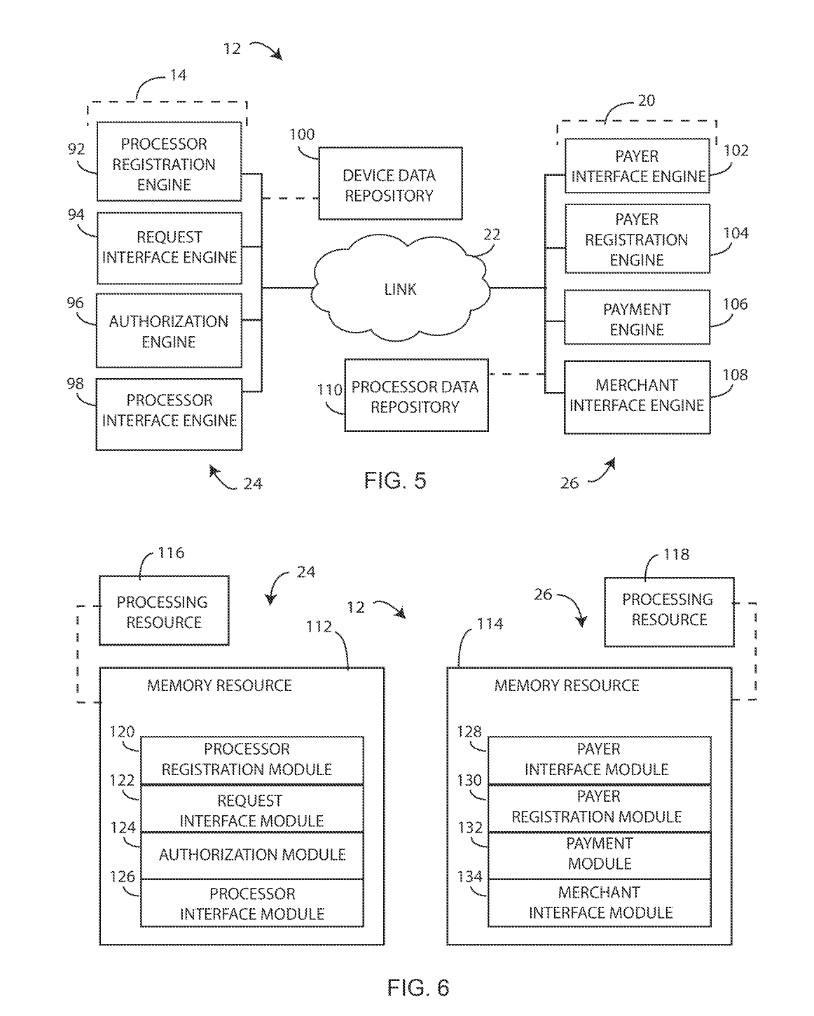

FIGS. 5-7 depict examples of physical and logical components for implementing various embodiments. In FIG. 5 various components are identified as engines 92-98 and 102-108. In describing engines 92-98 and 102-108, focus will be on each engine's designated function. However, the term engine, as used herein, refers to a combination of hardware and programming configured to perform a designated function. As is illustrated later with respect to FIG. 6, the hardware of each engine, for example, may include a processor and a memory, while the programing is code stored on that memory and executable by the processor to perform the designated function.

FIG. 5 depicts transaction system 12 for affecting a monetary transaction between a user of a client device and a merchant. As described with respect to FIG. 1, system 12 includes payment subsystem 26 and processor subsystem 26. In FIG. 2, payment subsystem is implemented by a client device 14 in combination with payment application 30. Here, payment subsystem 24 is shown to include processor registration engine 92, request interface engine 94, authorization engine 96, and processor interface engine 98.

Processor registration engine 92 is configured to maintain registration data and masked payment data. The registration data represents a registration of a client device and corresponding programming implementing payment subsystem 24 with a remote payment processing system. Here that payment processing system is depicted as processor subsystem 26. The term remote is used only to indicate that the payment processing system is not operating on or otherwise implemented by the client device used for payment subsystem 24. The masked payment data indirectly, but not directly, identifies payment data. In other words, the masked payment data can be used to identify corresponding payment data but not used to easily derive that payment data.

In performing it function processor registration engine 92 may communicate with the remote payment processor to obtain registration data associating payment subsystem 14 with a payment account maintained by the remote payment processor. Processor registration engine 92 may collect payment data from a user and generate the masked payment data from the collected payment data. The masked payment data, for example, may be a hash of the collected payment data that can be used to identify matching payment data maintained by processing subsystem 26. The hash itself is not well suited for deriving the payment data it represents. Processor registration engine 92 discards the collected payment data and stores the registration data and the masked payment data in device data repository 100. Repository 100 represents generally any storage memory accessible to payment subsystem 12. For example repository 100 may be integrated memory of a client device implementing subsystem 24 or external memory accessible to that client device.

Request interface engine 94 is configured to receive payment requests from a merchant application. In doing so request interface engine may expose an application programming interface accessible to the merchant application for submitting the payment request for a specified amount. Request interface engine 94 is also configured to pass data back to the merchant application in response to the payment request. In the example of FIG. 3, the payment request may be communicated upon the user selecting control 80.

Authorization engine 96 is configured to, in response to receipt of a payment request by request interface engine 94, prompt the user for authorization data. Such may be accomplished by causing a display of a prompt that identifies the amount to be paid, the merchant, and asks the user to enter an authorization code. FIG. 4 depicts such an example. Authorization engine 96 is also responsible for verifying authorization data supplied by the user in response to the prompt.

Processor interface engine 98 in configured to, only upon verification of the authorization data, communicate the registration data, the masked payment data, and the amount request to the payment processing system. In operation processor interface engine 98 receives indication that a user has supplied verified authorization data and in response access the transaction data and masked payment data from device data repository 100 passing that data onto processing subsystem 26. In communicating the amount, processor interface engine 98 may communicate the amount specified by the payment request, the amount and data identifying the merchant, or simply forward the payment request itself.

Assuming, processing subsystem 26 successfully initiates a transaction based on the data supplied, processor interface engine 98 receives transaction data in a response. The transaction data is for use in claiming payment of the requested amount. Request interface engine 94 then passes that transaction data back to the merchant application making the initial payment request. Where processor interface engine passes data identifying the merchant to processing subsystem 26, the transaction data returned may identify that merchant or only be designed for use by only that merchant to claim payment.

Processor 92 registration engine may be configured to maintain masked payment data for each of a plurality of payment accounts. For example, the user may have two multiple payment cards including one for personal and one for business. The same registration data may apply or each the masked payment data for each payment card may be associated with its own registration data. In this situation, authorization engine 96 when prompting for an authorization code also prompts the user to select a desired payment card for use in processing the transaction. Processor interface engine 98 then sends the registration data and masked payment data for the selected card but only upon confirmation that the user has supplied a verified authorization code.

Processing subsystem 26 is shown to include a payer interface engine 102, payer registration engine 104, payment engine 106, and merchant interface engine 108. Payer interface engine 102 is configured to receive a communication from payment subsystem 24, the communication including registration data, masked payment data and an amount. The amount may be communicated as part of a payment request received by payment subsystem 204 from a merchant application. That request may also identify the merchant expected to claim payment.

Payer registration engine 104 is configured to utilize the registration data to identify a payment account and verify the masked payment data against payment data associated with the identified payment account. In an example, payer registration engine 104 uses the registration data to identify a payment account from among a plurality of payment accounts maintained in processor data repository 110. Such payment accounts include an account identifiers. The registration data is useable by payer registration engine 104 to identify a payment account by matching the registration data to a corresponding account identifier. Each payment account includes payment data such as an account number and verification data such as a personal identification number, a card verification code, and a billing address. The hashed payment data may be a hash of payment data supplied to payment subsystem 24. The masked payment data is verified if that hash matches a hash of the payment data contained in the identified payment account.

Payment engine 106 is configured to, only upon identification of the user account and verification of the masked payment data, initiate a transaction for the requested amount using the payment data associated with the identified payment account. In doing so payment engine 106 may communicate the amount and the payment data to a corresponding issuer for further processing. Assuming the corresponding account balance allows for completion of the transaction in the requested amount as verified by payment engine 106 or the issuer, payer interface engine communicates transaction data back to payment subsystem 24 for use by the requesting merchant to claim payment. Merchant interface engine 108 is configured to receive the transaction data from a merchant and, in response, process payment of the amount for the merchant.

In foregoing discussion, various components were described as combinations of hardware and programming. Such components may be implemented in a number of fashions. Looking at FIG. 6, the programming may be processor executable instructions stored on tangible memory resource 112 or 114 and the hardware may include processing resource 116 or 118 for executing those instructions. Thus memory resource 112 or 114 can be said to store program instructions that when executed by a corresponding processing resource 116 or 118 implement system 12 as a whole and subsystems 24 and 26 individually. Stated another way, memory resource 112 and processing resource 116 may function together to implement payment subsystem 26. Memory resource 114 and processing resource 118 may function together to implement processing subsystem 26.

Memory resource 112 represents generally any number of memory components capable of storing instructions that can be executed by processing resource 116. Likewise, memory resource 114 represents generally any number of memory components capable of storing instructions that can be executed by processing resource 118. Memory resources 112 and 114 are each non-transitory in the sense that neither encompasses a transitory signal but instead is made up of more or more memory components configured to store the relevant instructions. Memory resources 112 and 114 may each be implemented in a single device or distributed across devices. Likewise, each processing resource 116 and 118 represents any number of processors capable of executing instructions stored by a corresponding memory resource 112 or 114. Each processing resource 116 and 118 may be integrated in a single device or distributed across devices. Memory resource 112 may be fully or partially integrated in the same device as processing resource 116, or it may be separate but accessible to that device and processing resource 116. Memory resource 114 may be fully or partially integrated in the same device as processing resource 118, or it may be separate but accessible to that device and processing resource 118.

In one example, the program instructions can be part of an installation package that when installed can be executed by a corresponding processing resource 116 or 118 to implement a corresponding subsystem 24 or 26. In this case, memory resource 112 or 114 may be a portable medium such as a CD, DVD, or flash drive or a memory maintained by a server from which the installation package can be downloaded and installed. In another example, the program instructions may be part of an application or applications already installed. Here, memory resource 112 or 114 can include integrated memory such as a hard drive, solid state drive, or the like.

In FIG. 6, the executable program instructions stored in memory resource 112 are depicted as processor registration module 120, request interface module 122, authorization module 124, and processor interface module 126. Processor registration module 120 represents program instructions that when executed cause processing resource 116 to implement processor registration engine 92 of FIG. 5. Request interface module 122 represents program instructions that when executed cause the implementation of request interface engine 94. Likewise, authorization module 124 and processor interface module 128 represent program instructions that when executed cause the implementation of authorization engine 96 and processor interface engine 98.

In FIG. 6, the executable program instructions stored in memory resource 114 are depicted as payer interface module 128, payer registration module 130, payment module 132, and merchant interface module 134. Payer interface module 128 represents program instructions that when executed cause processing resource 118 to implement payer interface engine 102 of FIG. 5. Payer registration module 122 represents program instructions that when executed cause the implementation of payer registration engine 10. Likewise, payment module 132 and merchant interface module 134 represent program instructions that when executed cause the implementation of payment engine 106 and merchant interface engine 108.

### CONCLUSION

FIG. 1 depicts an exemplary environment in which embodiment may be implemented. It is noted that implementation is not limited to that environment. Although the sequence diagram of FIG. 2 shows a specific order of execution, the order of execution may differ from that which is depicted. For example, the order of execution of two or more steps may be scrambled relative to the order shown. Also, two or more steps shown in succession may be executed concurrently or with partial concurrence.

FIGS. 3 and 4 depict example screen views of various user interfaces. The particular layouts and designs of those user interfaces are examples only. FIGS. 5-6 aid in depicting the architecture, functionality, and operation of various embodiments. In particular, FIGS. 5-6 depict various physical and logical components. Various components are defined at least in part as programs or programming. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Embodiments can be realized in any memory resource for use by or in connection with processing resource. A “processing resource” is an instruction execution system such as a computer/processor based system or an ASIC (Application Specific Integrated Circuit) or other system that can fetch or obtain instructions and data from computer-readable media and execute the instructions contained therein. A “memory resource” is any non-transitory storage media that can contain, store, or maintain programs and data for use by or in connection with the instruction execution system. The term “non-transitory is used only to clarify that the term media, as used herein, does not encompass a signal. Thus, the memory resource can comprise any one of many physical media such as, for example, electronic, magnetic, optical, electromagnetic, or semiconductor media. More specific examples of suitable computer-readable media include, but are not limited to, hard drives, solid state drives, random access memory (RAM), read-only memory (ROM), erasable programmable read-only memory, flash drives, and portable compact discs.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A computing device, comprising a processing resource and a memory resource storing instructions that when executed cause the processing resource to:
maintain registration data and masked payment data, the registration data representing a registration of the computing device with a remote payment processing system, the masked payment data indirectly, but not directly, identifying payment data associated with a user;
expose an application programming interface for receiving a payment request from a merchant application;
in response to receiving the payment request for an amount via the interface, prompt the user for authorization data; and
only upon verification of the authorization data, communicate the registration data, the masked payment data, and the amount to the payment processing system.

2. The device of claim 1, wherein the memory resource stores instructions that when executed cause the processing recourse to:
receive transaction data from the payment processing system in response to the communication of the registration data, masked payment data, and amount; and
communicate the transaction data to the merchant application.

3. The device of claim 2, wherein:
the payment request includes merchant data identifying a merchant;
the instructions that when executed cause the processing resource to communicate comprise instructions that when executed cause the processing resource to, only upon authorization input verification, communicate the merchant data to the payment processing system; and
the transaction data is for use by the merchant to claim payment to an account associated with the merchant.

4. The device of claim 1, wherein the instructions that when executed cause the processing resource to maintain comprise instructions that when executed cause the processing resource to:
prompt the user for the payment data;
generate the masked payment data from payment data received from the user, the masked payment data being a hash of the payment data;
obtain the registration data from the payment processing system;
locally store the registration data and the masked payment data, but not the account data, for later use.

5. The device of claim 1, wherein:
the instructions that when executed cause the processing resource to maintain comprise instructions that when executed cause the processing resource to maintain first masked payment data indirectly, but not directly, identifying first payment data and second masked payment data indirectly, but not directly, identifying second payment data;
the instructions that when executed cause the processing resource to prompt a user for authorization input include instructions that when executed cause the processing resource to prompt a user to identify one of a first payment account associated with the first payment data and a second payment account associated with the second payment data; and
the instructions that when executed cause the processing resource to communicate comprise instructions that when executed cause the processing resource to, only upon authorization input verification, communicate the registration data and the masked payment data for the selected one of the first and second payment accounts, and the amount to the payment processing system.

6. A payment system comprising a processing subsystem, the processing engine including a payer interface engine, a payer registration engine, and a payment engine, wherein:
the payer interface engine is configured to receive a communication from a payment subsystem, the communication including registration data, masked payment data indirectly, but not directly identifying payment data, and an amount;
the payer registration engine is configured to utilize the registration data to identify a payment account and verify the masked payment data against payment data associated with the identified payment account;
the payment engine is configured to, only upon identification of the user account and verification of the masked payment data, initiate a transaction for the amount using the payment data associated with the identified payment account; and
the application interface engine is configured to communicate transaction data back to the payment subsystem, the transaction data for use in claiming payment for the amount.

7. The system of claim 6, wherein the payment subsystem is responsible for communicating the transaction data to a merchant and the processing subsystem in includes a merchant interface engine configured to receive the transaction data and, in response, process payment of the amount for the merchant.

8. The system of claim 6, wherein the masked account data is a first hash of payment data and wherein the payer registration engine is configured to verify the masked payment data by comparing the first hash against a second hash of the payment data associated with the identified payment account.

9. The system of claim 6, comprising the payment subsystem, the payment subsystem including a request interface engine, an authorization engine, and a processor interface engine, wherein:
the request interface engine is configured to receive a payment request for an amount from a merchant application;
the authorization engine is configured to prompt a user for authorization data in response to receipt of the payment request and to verify the authorization data;
the processor interface engine is configured to, only upon verification of the authorization data, communicate the registration data, the masked payment data, and the amount to the processor subsystem and, in response, receive the transaction data; and
the request interface engine is configured to communicate the received transaction data to the merchant application.

10. The system of claim 9, wherein the payment subsystem includes a processor registration engine configured to:
obtain the registration data from the processing subsystem;
obtain payment data from a user;
generate the masked payment data from obtained payment data; and
locally store the registration data and the masked payment data but not the obtained payment data.

11. A payment processing method implemented by a computing device having a local memory, comprising:
receiving a payment request for an amount from a merchant application via an application programming interface;
causing a display of a prompt for a user to enter an authorization code, the prompt prompting the user for an authorization code;
only upon verification of an authorization code supplied in response to the prompt, communicating registration data and masked payment data to a remote processing subsystem accessed from the local memory, the registration data identifying a payment account, the masked payment data indirectly, but not directly, identifying payment data associated with the payment account;
receiving transaction data from the processing subsystem; and
communicating the transaction data to the merchant application.

12. The method of claim 11, comprising:
generating the masked payment data from payment data supplied by a user;
obtaining the registration data from the processing subsystem; and
storing the registration data and the masked payment data but not the supplied payment data in the local memory.

13. The method of claim 12, wherein:
the supplied payment data included payment data for a first payment account and payment data for a second payment account;
generating comprises generating first masked payment data indirectly identifying the first payment data and a second masked payment data indirectly identifying the second payment data;
storing comprises storing the first and second masked payment date but not the first and second payment data in the local memory.

14. The method of claim 13, wherein:
causing a display comprises causing a display of the prompt for the user to enter an authorization code and to select between the first and second payment accounts, the amount, and data at least indirectly identifying the merchant application; and
communicating comprises communicating the registration data and masked payment data for the selected one of the payment accounts to the remote processing subsystem.

15. The method of claim 11, wherein the transaction data includes data for claiming payment if the transaction subsystem successfully identified an payment account associated with the registration data and verified the masked payment data against payment data associated with the identified payment account and otherwise data indicative payment failure.
